(19) United States
(12) Patent Application Publication
(10) Pub. No.: US 2015/0103056 A1
(43) Pub. Date: Apr. 16, 2015

(54) Calibrating an Electronic Writing Device

(71) Applicant: Motorola Mobility LLC, Libertyville, IL (US)

(72) Inventors: Swee M. Mok, Palatine, IL (US); Mary K. Hor-Lao, Vernon Hills, IL (US); Jason Jae Hyun Koh, Vernon Hills, IL (US); Douglas A. Lautner, Round Lake, IL (US); Daniel T. Moore, Arlington Heights, IL (US)

(73) Assignee: Motorola Mobility LLC, Libertyville, IL (US)

(21) Appl. No.: 14/078,697

(22) Filed: Nov. 13, 2013

Related U.S. Application Data
(60) Provisional application No. 61/889,932, filed on Oct. 11, 2013.

(51) Int. Cl. G06F 3/0354

(52) U.S. Cl. CPC G06F 3/03545
USPC 345/179

(57) ABSTRACT

In embodiments of calibrating an electronic writing device, an electronic writing device includes a calibration component configured to calibrate writing data to an orientation of a writing surface. To do so, the calibration component determines whether writing data corresponds to a calibration movement. If the calibration component determines that the writing data corresponds to the calibration movement, the calibration component determines a correction angle based on the writing data and stores the correction angle in a writing buffer. The calibration component then uses the correction angle to adjust subsequently received writing data to align the writing data to the orientation of the writing surface.

### PRIORITY

This application claims the benefit of U.S. Provisional Application Ser. No. 61/889,932, filed Oct. 11, 2013, the entire contents of which are hereby incorporated herein by reference in their entirety.

### BACKGROUND

An electronic pen can utilize sensors to detect writing movements when writing on a writing surface, such as a piece of paper. An electronic pen and a piece of paper are independent objects, and thus the electronic pen's recorded writing may be tilted at an arbitrary angle relative to the piece of paper causing the written words to appear “rotated” compared to the user's intended orientation.

### BRIEF DESCRIPTION OF THE DRAWINGS

Embodiments of calibrating an electronic writing device are described with reference to the following Figures. The same numbers may be used throughout to reference like features and components that are shown in the Figures:

FIG. 1 illustrates an example system in which embodiments of calibrating an electronic writing device can be implemented.

FIG. 2 illustrates an example of an electronic writing device writing on a writing surface.

FIG. 3 illustrates an example of un-calibrated writing data generated by an electronic writing device.

FIG. 4 illustrates an example of a calibration movement of an electronic writing device in accordance with one or more embodiments.

FIG. 5 illustrates an example of adjusting writing data by a correction angle.

FIG. 6 illustrates an example of various orientations of an electronic writing device relative to a writing surface.

FIG. 7 illustrates an example of a calibration movement of electronic writing device in accordance with one or more embodiments.

FIG. 8 illustrates an example of determining whether a calibration movement of an electronic writing device is within one or more angle thresholds in accordance with one or more embodiments.

FIG. 9 illustrates an example of determining a correction angle based on a calibration movement in accordance with one or more embodiments.

FIG. 10 illustrates an example method of calibrating an electronic writing device in accordance with one or more embodiments.

FIG. 11 illustrates various components of an example computer device that can implement embodiments of calibrating an electronic writing device.

### DETAILED DESCRIPTION

In embodiments of calibrating an electronic writing device, an electronic writing device includes a calibration component configured to calibrate writing data to an orientation of a writing surface. To do so, the calibration component determines whether writing data corresponds to a calibration movement. If the calibration component determines that the writing data corresponds to the calibration movement, the calibration component determines a correction angle based on the writing data and stores the correction angle in a writing buffer. The calibration component then uses the correction angle to adjust subsequently received writing data to align the writing data to the orientation of the writing surface.

While features and concepts of calibrating an electronic writing device can be implemented in any number of different devices, systems, and/or configurations, embodiments of calibrating an electronic writing device are described in the context of the following example devices, systems, and methods.

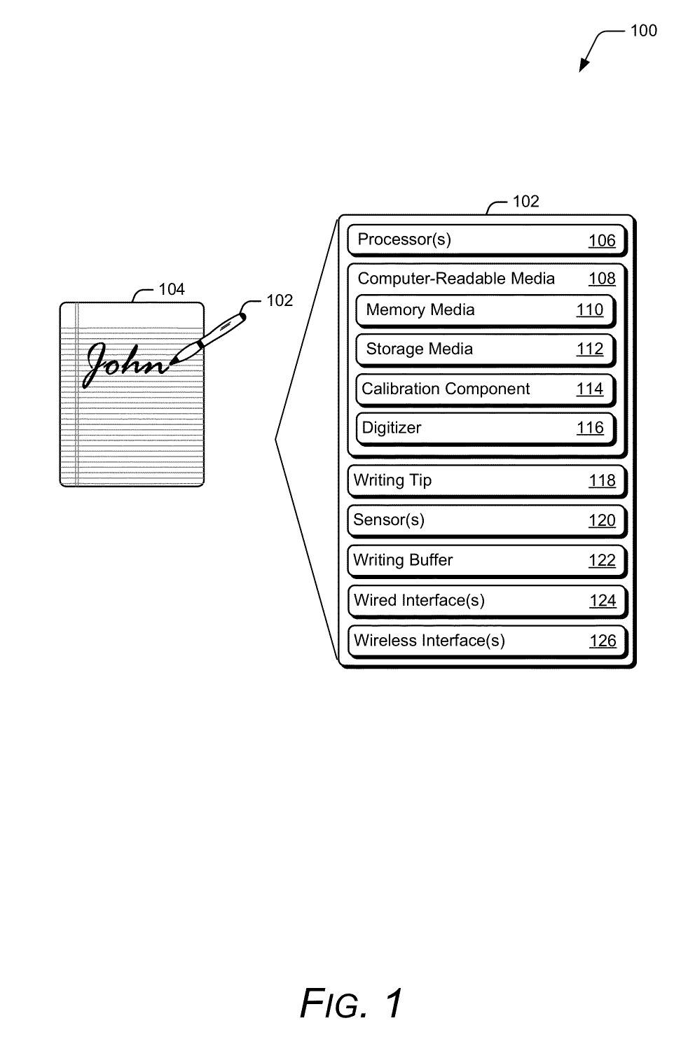

FIG. 1 illustrates an example environment 100 in which embodiments of calibrating an electronic writing device can be implemented. Example environment 100 includes an electronic writing device 102 that is configured to write on a writing surface 104. Electronic writing device 102 is illustrated in example 100 as an electronic pen, but may also be implemented as an electronic mouse or any other type of electronic writing device. Writing surface 104 may be implemented as a piece of paper, but may also be implemented as other surfaces, such as a poster board, a white board, a chalk board, a tabletop, or a tablet. As described herein, “writing” includes any type of writing or drawing on writing surface 104 by electronic writing device 102, such as scripting, printing, signing, drafting, illustrating, tracing, diagramming, marking, or scribbling, to name just a few.

Electronic writing device 102 includes processors 106 and computer-readable media 108, which may include memory media 110 and storage media 112. Computer-readable media 108 also includes a calibration component 114 and a digitizer 116, which will be described in more detail below.

Electronic writing device 102 further includes a writing tip 118, sensor(s) 120, and a writing buffer 122. Writing tip 118 is usable to write on writing surface 104, and may be implemented, by way of example and not limitation, as an ink tip or a pencil tip. For example, writing tip 118 may enable electronic writing device to write in ink or in pencil on a piece of paper.

Sensors 120 are configured to sense movement of electronic writing device 102 when writing on writing service 104, and to generate writing data corresponding to the movement of electronic writing device 102. For example, the movement senses by sensors 120 can be passed to digitizer 116 which converts the movement into digital writing data.

In one or more embodiments, sensors 120 are implemented as optical sensors, similar to those used in computer mouse input devices. Optical sensors are configured to sense movement of electronic writing device 102 in the “x” and “y” directions, and to generate writing data in the form of x-coordinates and y-coordinates corresponding to the writing of the electronic writing device 102. Writing buffer 122 is configured to store the writing data generated by sensors 120.

Electronic writing device 102 may also include one or more wired interface(s) 124 and/or wireless interface(s) 126 that are configured to communicate writing data stored in writing buffer 122 to an external computing device. For example, wired interface 124 may be implemented as a universal serial bus (USB) device that can be inserted into a computing device to transfer the data in writing buffer 122 to the computing device. As another example, wireless interface 126 may be implemented as a Bluetooth™ device configured to wirelessly communicate writing data in writing buffer 122 to an external computing device that is also equipped with a Bluetooth™ device.

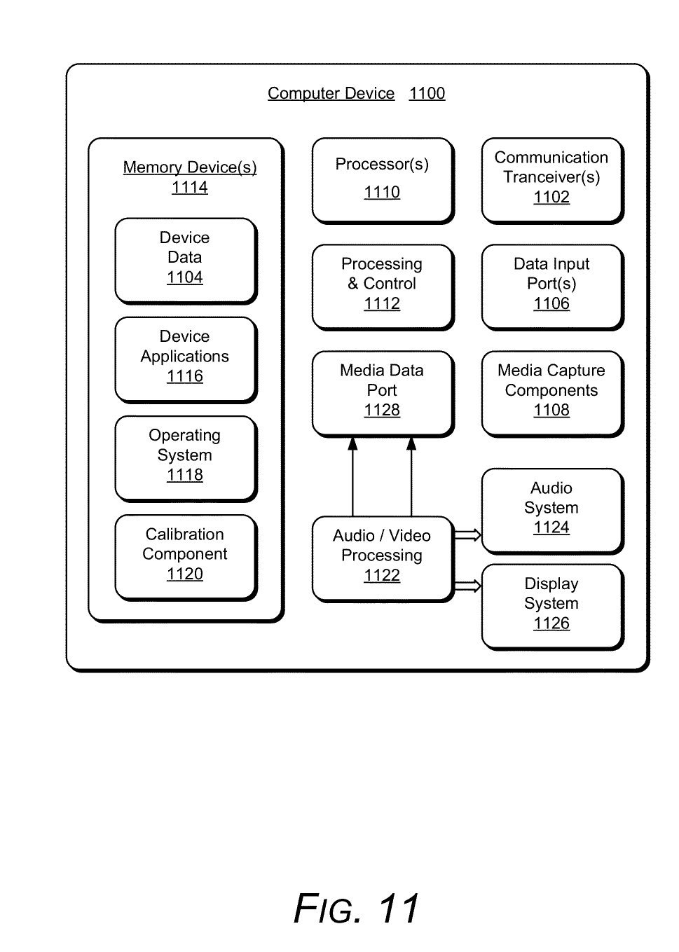

Electronic writing device 102 can also be implemented with any number and combination of differing components as further described with reference to the example device shown in FIG. 11.

### Un-Calibrated Writing Data

Electronic writing device 102 and writing surface 104 are independent objects, and thus sensor 120 may not know the orientation of writing surface 104 relative to electronic writing device 102. As a result, the writing data generated by electronic writing device 102 may be tilted at an arbitrary angle relative to writing surface 104 causing the words to appear “rotated” compared to the user's intended orientation.

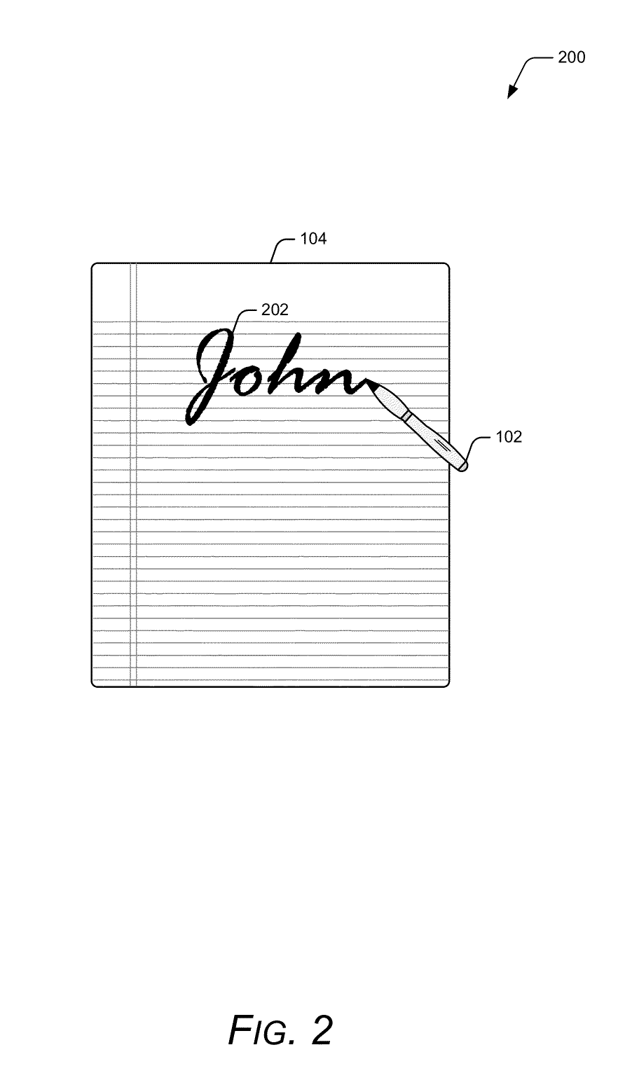

Consider, for example, FIG. 2 which illustrates an example 200 of electronic writing device 102 writing on writing surface 104. In this example, electronic writing device 102 has been used to generate writing 202 (the word “John”), on writing surface 104. Due to the way in which the user holds electronic writing device 102 and/or the orientation of writing surface 104 relative to electronic writing device 102, sensors 120 may incorrectly sense the orientation of the writing data generated by electronic writing device 102.

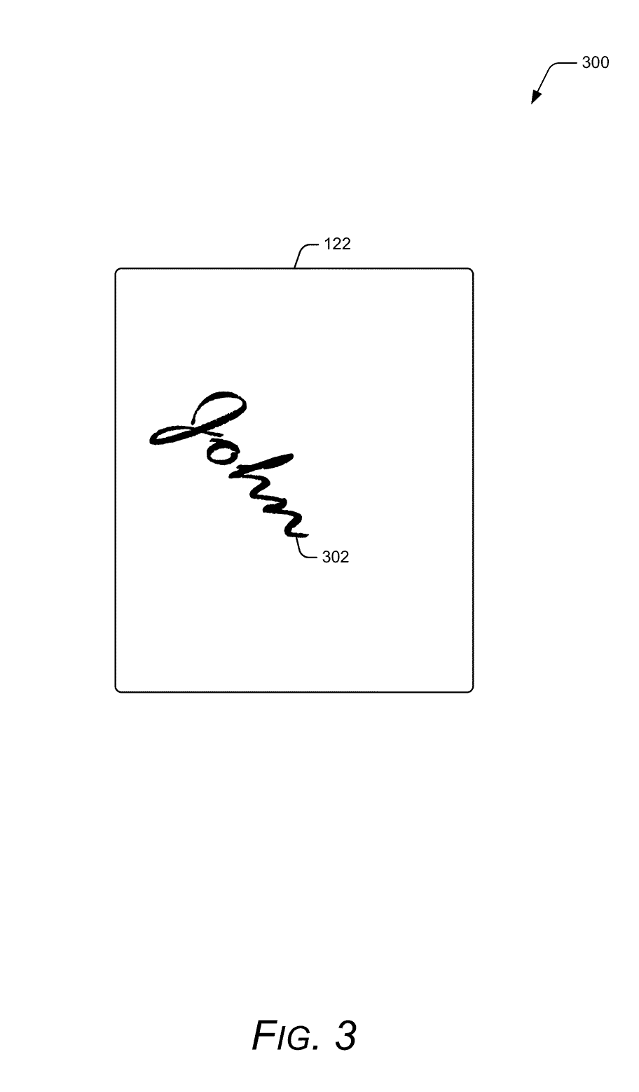

Consider, for example, FIG. 3 which illustrates an example 300 of un-calibrated writing data generated by electronic writing device 102. In this example, the electronic writing device 102 senses and stores un-calibrated writing data 302 in writing buffer 122 responsive to electronic writing device 102 being used to generate writing 202 on writing surface 104 in FIG. 2. Note that the orientation of un-calibrated writing data 302 in writing buffer 122 is not the same as the orientation of writing 202 relative to writing surface 104.

### Calibrating the Electronic Writing Device

In accordance with various embodiments, calibration component 114 is configured to calibrate electronic writing device 102 so that the writing data is aligned with the orientation of writing surface 104. To do so, calibration component 114 can determine when writing data corresponds to a calibration movement, and then determine a correction angle based on the calibration movement.

In various embodiments the calibration movement is one or more substantially straight lines drawn on writing surface 104 using electronic writing device 102. In some embodiments, the calibration movement may be single straight line drawn substantially parallel to an axis of writing surface 104, such as the horizontal axis of writing surface 104 or the vertical axis of writing surface 104. In other embodiments, a first line is drawn in a first direction, and a second line is traced back over the first line to the starting point of the first line. Using two lines for the calibration movement may decrease the likelihood of detecting a calibration movement that is unintended by the user. It is to be appreciated, however, that a variety of different calibration movements may be detected by calibration component 114.

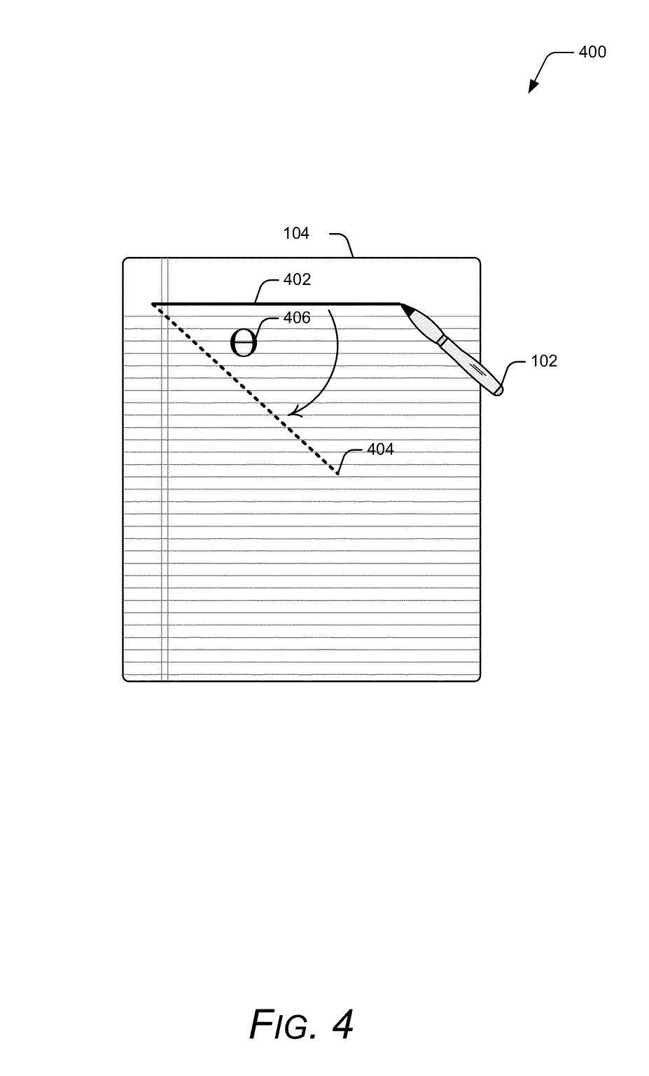

Calibration component 114 can detect the calibration movement by detecting that a substantially straight line has been drawn on writing surface 104 using electronic writing device 102. Consider, for example, FIG. 4 which illustrates an example 400 of a calibration movement of electronic writing device 102 in accordance with one or more embodiments. In this example, electronic writing device 102 has been used to generate writing that corresponds to a calibration movement 402 on writing surface 104. Calibration movement 402, in this example, is a straight line drawn substantially parallel to an x-axis of writing surface 104. More particularly in this example calibration movement 402 is drawn substantially parallel to a top edge of a piece of paper. In some embodiments, calibration movement 402 may be drawn substantially parallel to a y-axis of writing surface 104 (e.g., substantially parallel to a side edge of a piece of paper).

Example 400 further illustrates a representation of writing data 404 that is generated when calibration movement 402 is drawn on writing surface 104. As described above, writing data 404 is tilted or rotated based on the orientation of writing surface 104 relative to electronic writing device 102.

After detecting calibration movement 402, calibration component 114 determines a correction angle 406 based on the calibration movement. The correction angle is computed as the difference between the calibration movement 402 and the writing data detected by sensors 120. Thus, the correction angle can be used to adjust the detected writing data so that it aligns with the orientation of writing surface 104. Note, therefore, that the calibration movement does not need to be drawn parallel to an axis of the writing surface, because the calibration component will rotate the writing data to align with the orientation intended by the user. For example, a user may purposely want to calibrate electronic writing device 102 to an artwork that is slanted at 60 degrees within writing surface 104 so technical construction lines that are aligned to this slanted artwork can be drawn. After detecting the correction angle, calibration component 114 stores the correction angle in writing buffer 122.

Subsequently, when additional writing data is received, calibration component 114 can retrieve the stored correction angle from writing buffer 122, and adjust the writing data using the stored correction angle to align the writing data with the orientation of writing surface 104.

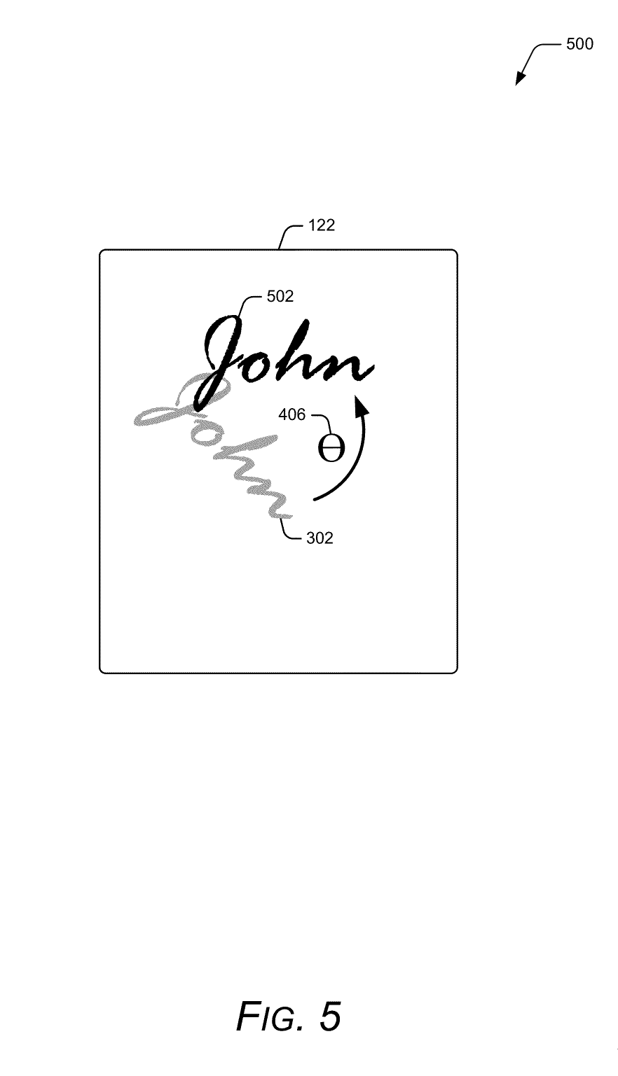

Consider, for example, FIG. 5 which illustrates an example 500 of adjusting writing data by a correction angle. In this example, writing buffer 122 stores un-calibrated writing data 302 which was generated from writing 202 in FIG. 2. Calibration component 114, however, can adjust un-calibrated writing data 302 by correction angle 406 to generate calibrated writing data 502 which is aligned to the orientation of writing surface 104. For example, to adjust the un-calibrated writing data 302, calibration component 114 adjusts the x-coordinates and the y-coordinates of un-calibrated writing data 302 by correction angle 406.

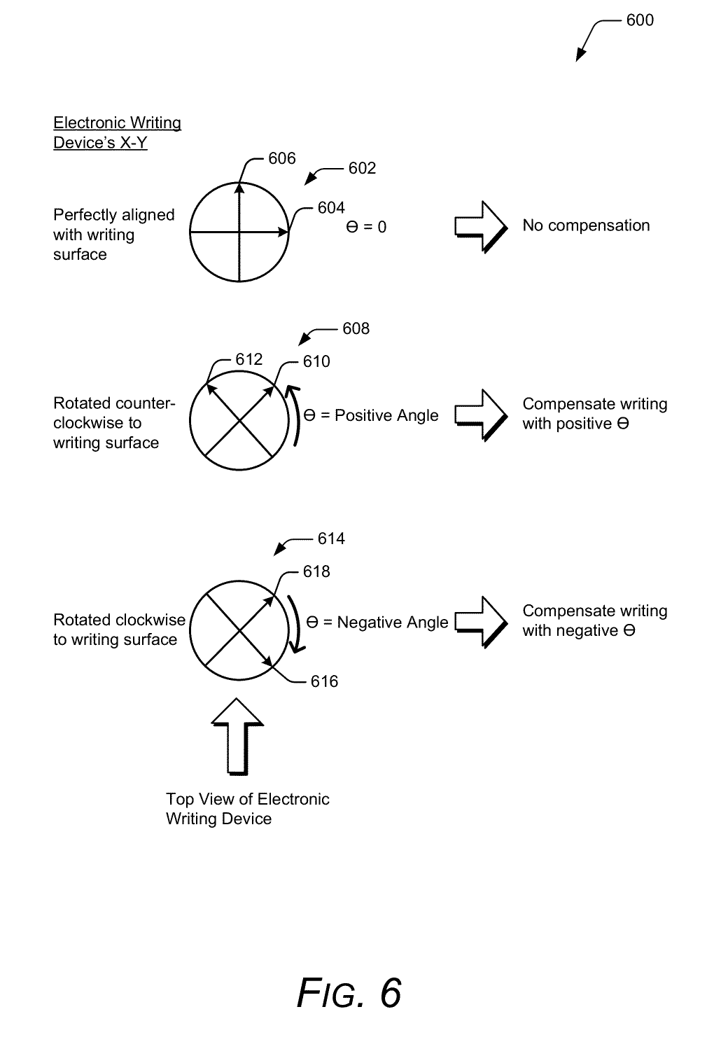

In order to better understand why writing data must be adjusted by a correction angle, consider FIG. 6 which illustrates an example 600 of various orientations of electronic writing device 102 relative to writing surface 104.

At 602, electronic writing device 102 is perfectly aligned with writing surface 104, as indicated by the x-axis 604 of electronic writing device 102 being aligned with the x-axis of writing surface 104, and the y-axis 606 of electronic writing device 102 being aligned with the y-axis of writing surface 104. In this case, the writing data does not need to be adjusted by calibration component 114.

In contrast, at 608, electronic writing device 102 is rotated counter-clockwise to writing surface 104, as indicated by the x-axis 610 of electronic writing device 102 being rotated counter-clockwise from the x-axis of writing surface 104, and the y-axis 612 of electronic writing device 102 being rotated counter-clockwise from the y-axis of writing surface 104. In this case, the writing data generated by electronic writing device 102 is rotated in a positive direction due to the orientation of electronic writing device 102. Thus, to align the writing data with the orientation of writing surface 104, calibration component 114 adjusts the writing data with a positive correction angle.

In contrast, at 614, electronic writing device 102 is rotated clockwise to writing surface 104, as indicated by the x-axis 616 of electronic writing device 102 being rotated clockwise from the x-axis of writing surface 104, and the y-axis 618 of electronic writing device 102 being rotated clockwise from the y-axis of writing surface 104. In this case, the writing data generated by electronic writing device 102 is rotated in a negative direction due to the orientation of electronic writing device 102. Thus, to align the writing data with the orientation of writing surface 104, calibration component 114 adjusts the writing data with a negative correction angle.

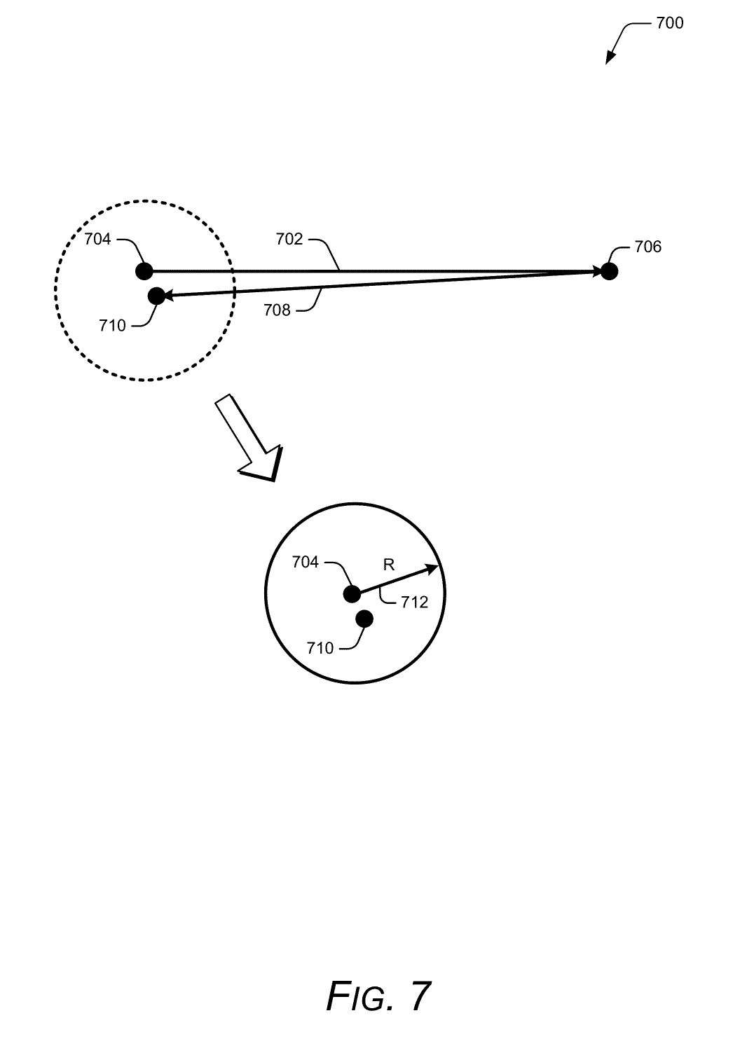

FIG. 7 illustrates an example 700 of a calibration movement of electronic writing device 102 in accordance with one or more embodiments. In this example, the calibration movement includes a first line 702 drawn using electronic writing device 102 from a first point 704 to a second point 706 on writing surface 104, and a second line 708 drawn using electronic writing device 102 from the second point 706 to a third point 710 on writing surface 104.

Calibration component 114 is configured to detect this calibration movement by detecting that two lines are drawn that are each substantially parallel to an axis of writing surface 104. For example, calibration component 114 may determine that two lines are drawn that are each substantially parallel to a horizontal axis or vertical axis of writing surface 104.

In one or more embodiments, calibration component 114 may detect the calibration movement if a length of each of first line 702 and second line 708 is greater than a line threshold length. For example, if first line 702 and second line 708 are drawn parallel to the horizontal axis of writing surface 104, calibration component may detect the calibration component only if a length between x-coordinates of first point 704 and second point 706, and a length between x-coordinates of second point 706 and third point 710 are greater than the line threshold length. Similarly, if first line 702 and second line 708 are drawn parallel to the vertical axis of writing surface 104, calibration component may detect the calibration component if a length between y-coordinates of first point 704 and second point 706, and a length between y-coordinates of second point 706 and third point 710 are greater than the line threshold length. In some cases, the line threshold length may be half of a width of writing surface 104, such as half of the width of a piece of paper.

In one or more embodiments, the starting point of the first line of the calibration movement and the ending point of the second line of the calibration movement must be near to each other. For example, in FIG. 7, calibration component 114 detects the calibration movement if third point 710 is within a predetermined radius 712 of first point 704. This ensures that first line 702 and second line 708 are drawn substantially close to each other, while allowing for some human error due to the difficulty in drawing two perfectly straight lines on top of each other.

In various embodiments, calibration component 114 determines that writing data corresponds to the calibration movement if first line 702 and/or second line 708 are within one or more angle thresholds.

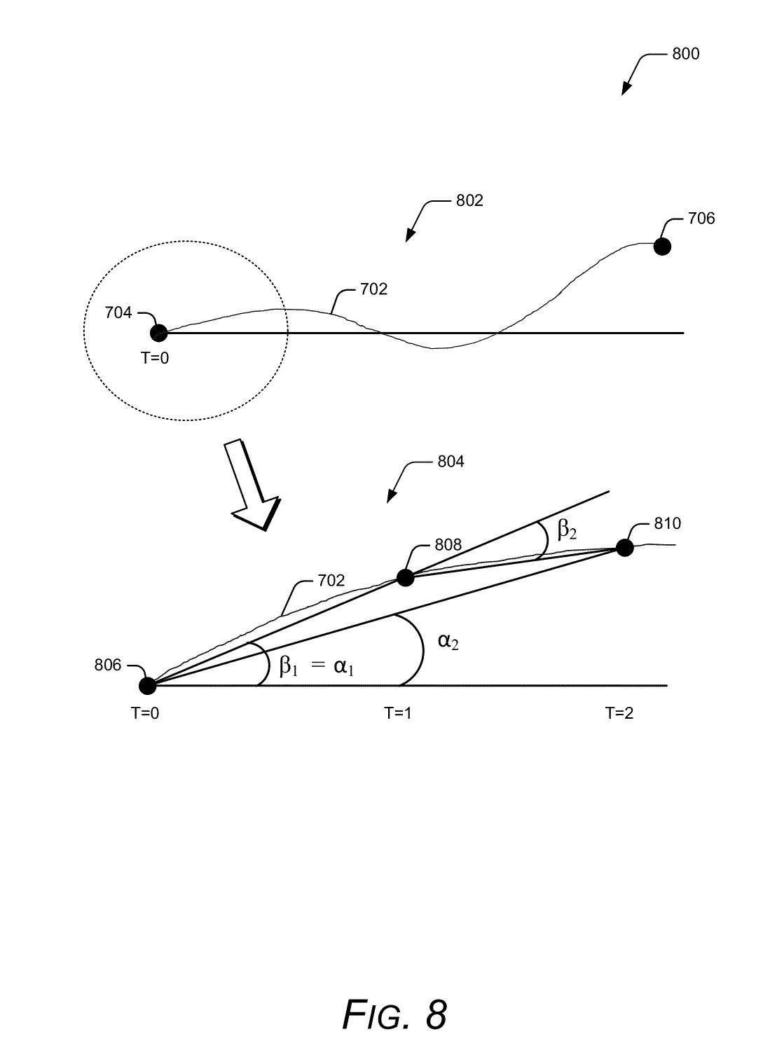

Consider, for example, FIG. 8 which illustrates an example 800 of determining whether a calibration movement of electronic writing device 102 is within one or more angle thresholds in accordance with one or more embodiments. At 802, a zoomed in version of first line 702 from FIG. 7 is illustrated between points 704 and 706. By zooming in on first line 702, it should be apparent that first line 702 is not perfectly straight, which is due to the difficulty of drawing a perfectly straight line on writing surface 104.

At 804, a portion of first line 702 is zoomed in on, and is illustrated at various different times, T=0, T=1, and T=2. In order to determine whether first line 702 is straight enough to qualify as a calibration movement, calibration component 114 determines whether first line 702 is within a first angle threshold. In this example, a first angle β₁ is calculated between a first point 806 of first line 702 corresponding to T=0 and a second point 808 of first line 702 corresponding to T=1. A second angle β₂ is calculated between second point 808 of first line 702 corresponding to T=1 and a third point 810 of first line 702 corresponding to T=2. In order for first line 702 to qualify as a calibration movement, calibration component 114 determines whether β₁ and β₂ are each within the first angle threshold.

Alternately or additionally, in order to determine whether first line 702 is straight enough to qualify as a calibration movement, calibration component 114 determines whether first line 702 is within a second angle threshold. In this example, a third angle α₁ is calculated between first point 806 of first line 702 corresponding to T=0 and second point 808 of first line 702 corresponding to T=1. In this case, α₁ is equal to β₁. A second angle α₂ is calculated between first point 806 of first line 702 corresponding to T=0 and third point 810 of first line 702 corresponding to T=2. In order for first line 702 to qualify as a calibration movement, calibration component 114 determines whether α₁ and α₂ are each within the second angle threshold.

In various embodiments, the first angle threshold is greater than the second angle threshold. In some cases, for example the first angle threshold may be approximately 25 degrees whereas the second angle threshold may be approximately 15 degrees. Requiring the calibration movement to be within both first angle threshold and second angle threshold ensures that the line of the calibration movement is substantially straight, thereby eliminating unintentional lines drawn using electronic writing device 102 from being interpreted as a calibration movement. Note that smaller values for first angle threshold and second angle threshold may result in higher accuracy, but may make it more difficult for the user to calibrate electronic writing device 102 because the user would have to draw a more perfectly straight line.

While only a single calibration line is illustrated in FIG. 8, it is to be appreciated that angle thresholds may be calculated in the same manner for a second calibration line. For example, on a return calibration movement from second point 706 to third point 710, second point 706 can be substituted into first point 704 for calculating the angles of β and α.

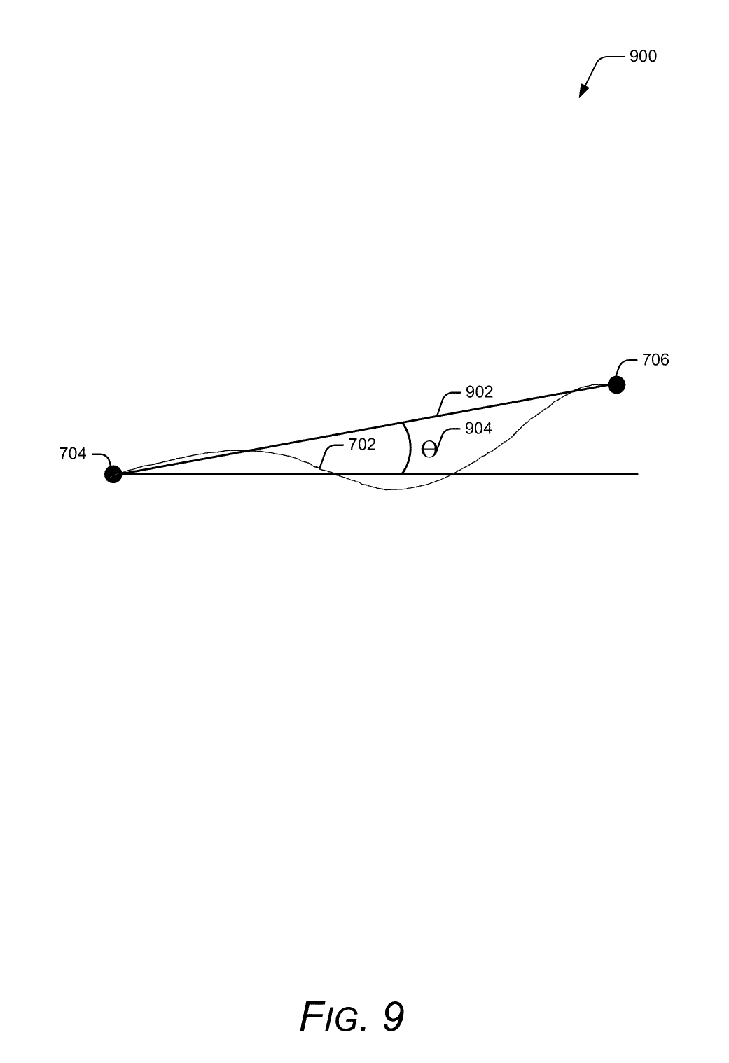

FIG. 9 illustrates an example 900 of determining a correction angle based on a calibration movement in accordance with one or more embodiments. After the electronic writing device calibration steps have been completed without violating the conditions for the one or more angle thresholds, a straight calibration line 902 is determined from the first point 704 to the second point 706 of first line 702. A correction angle 904 can then be determined as the angle between straight calibration line 902 and the axis of the paper, which in this example is illustrated as a horizontal axis. Alternately, correction angle 904 may be determined based on straight calibration line 902 that is determined from average positions of first point 704 and average positions of second point 706.

### Example Method

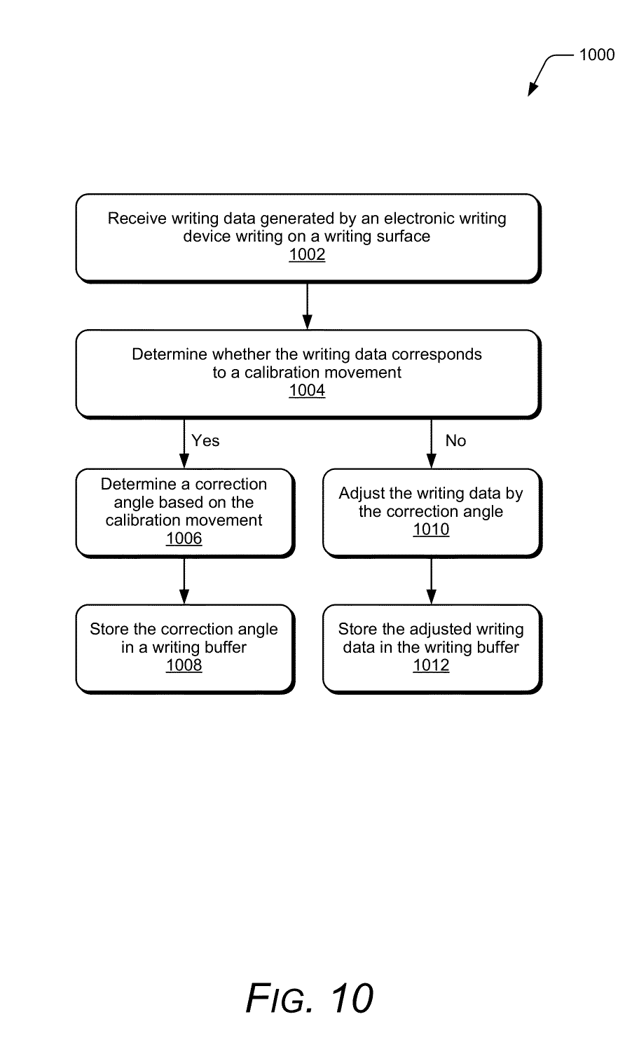

FIG. 10 illustrates an example method 1000 of calibrating an electronic writing device in accordance with one or more embodiments. The order in which the method blocks are described are not intended to be construed as a limitation, and any number or combination of the described method blocks can be combined in any order to implement a method, or an alternate method. Generally, any of the methods, components, and modules described herein can be implemented using software, firmware, hardware (e.g., fixed logic circuitry), manual processing, or any combination thereof. A software implementation represents program code that performs specified tasks when executed by a computer processor, and the program code can be stored in computer-readable storage media devices.

Block 1002 receives writing data generated by an electronic writing device writing on a writing surface. For example, calibration component 114 (FIG. 1) receives writing data generated by electronic writing device 102 writing on writing surface 104 from a sensor 120 of electronic writing device 102. As described throughout, electronic writing device 102 may be implemented as an electronic pen, and writing surface 104 may be implemented as a piece of paper.

Block 1004 determines whether the writing data corresponds to a calibration movement. For example, calibration component 114 determines whether the writing data corresponds to a calibration movement, such as one or more lines drawn substantially parallel to an axis of writing surface 104.

If it is determined that the writing data corresponds to the calibration movement, block 1006 determines a correction angle based on the calibration movement, and block 1008 stores the correction angle in a writing buffer. For example, calibration component 114 determines a correction angle 406 (FIG. 4) or a correction angle 904 (FIG. 9) based on the calibration movement, and stores the correction angle in writing buffer 122.

Alternately, if it is determined that the writing data does not correspond to the calibration movement, block 1010 adjusts the writing data by the correction angle, and block 1012 stores the adjusted writing data in the writing buffer. For example, calibration component 114 adjusts the un-calibrated writing data 302 by correction angle 406 to generate adjusted writing data 502, and stores the adjusted writing data in writing buffer 122 (FIG. 5).

FIG. 11 illustrates various components of an example computer device 1100 that can implement embodiments of calibrating an electronic writing device. For example, the computer device 1100 may be implemented as any type of electronic writing device that can write on a writing surface, such as a piece of paper, and generate electronic writing data corresponding to the writing on the writing surface.

The computer device 1100 includes communication transceivers 1102 that enable wired and/or wireless communication of device data 1104, such as received data, data that is being received, data scheduled for broadcast, data packets of the data, etc. Example communication transceivers 1102 include wireless personal-area-network (WPAN) radios compliant with various IEEE 802.15 standards, Bluetooth™ standards, wireless local-area-network (WLAN) radios compliant with any of the various IEEE 802.11 (also referred to as WiFi™) standards, wireless-wide-area-network (WWAN) radios for cellular telephony, wireless-metropolitan-area-network (WMAN) radios compliant with various IEEE 802.16 (also referred to as WiMAX™) standards, and wired local-area-network (LAN) Ethernet transceivers.

The computer device 1100 may also include one or more data input ports 1106 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the computer device to components, peripherals, or accessories such as microphones or cameras. Additionally, the computer device 1100 may include media capture components 1108, such as an integrated microphone to capture audio and a camera to capture still images and/or video media content.

The computer device 1100 includes one or more processors 1110 (e.g., any of microprocessors, controllers, and the like), which process computer-executable instructions to control operation of the device. Alternatively or in addition, the computer device can be implemented with any one or combination of software, hardware, firmware, or fixed logic circuitry that is implemented in connection with processing and control circuits, which are generally identified at 1112. Although not shown, the computer device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computer device 1100 also includes one or more memory devices 1114 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The computer device 1100 may also include a mass storage media device.

A memory device 1114 provides data storage mechanisms to store the device data 1104, other types of information and/or data, and various device applications 1116 (e.g., software applications). For example, an operating system 1118 can be maintained as software instructions within a memory device and executed on the processors 1110. The device applications may also include a device manager, such as any form of a control application, software application, signal-processing and control module, code that is native to a particular device, a hardware abstraction layer for a particular device, and so on. In embodiments, the computer device also includes a calibration component 1120. Calibration component 1120 is an example of calibration component 114 at electronic writing device 102 shown in FIG. 1.

The computer device 1100 also includes an audio and/or video processing system 1122 that generates audio data for an audio system 1124 and/or generates display data for a display system 1126. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1128. Additionally, the audio system and/or the display system may be external components to the computer device, or alternatively, are integrated components of the example computer device.

Although embodiments of calibrating an electronic writing device have been described in language specific to features and/or methods, the subject of the appended claims is not necessarily limited to the specific features or methods described. Rather, the specific features and methods are disclosed as example implementations of calibrating an electronic writing device.

1. An electronic writing device comprising:
a writing tip to enable writing on a writing surface;
one or more sensors configured to sense movement of the electronic writing device when writing on the writing surface, and to generate writing data corresponding to the movement of the electronic writing device;
a writing buffer configured to store the writing data; and
at least a memory and a processor to implement a calibration component, the calibration component configured to:
receive the writing data from the one or more sensors;
determine whether the writing data corresponds to a calibration movement;
determine a correction angle based on the calibration movement and store the correction angle in the writing buffer if the writing data corresponds to the calibration movement; and
adjust the writing data by a previously-determined correction angle and store the adjusted writing data in the writing buffer if the writing data does not correspond to the calibration movement.

2. The electronic writing device of claim 1, wherein the calibration component is configured to determine that the writing data corresponds to the calibration movement by detecting that the writing data corresponds to a line drawn substantially parallel to an axis of the writing surface using the electronic writing device, the axis comprising a horizontal axis of the writing surface or a vertical axis of the writing surface.

3. The electronic writing device of claim 2, wherein the calibration component is configured to determine the correction angle by:
determining a straight calibration line from a first point of the line to a second point of the line; and
determining the correction angle as an angle between the calibration line and the axis of the writing surface.

4. The electronic writing device of claim 1, wherein the calibration component is configured to determine that the writing data corresponds to the calibration movement by detecting that the writing data corresponds to a line drawn substantially straight on the writing surface using the electronic writing device.

5. The electronic writing device of claim 1, wherein the calibration component is configured to determine that the writing data corresponds to the calibration movement by:
detecting that the writing data corresponds to a first line drawn using the electronic writing device from a first point to a second point on the writing surface, and to a second line drawn using the electronic writing device from the second point to a third point on the writing surface;
detecting that the first line and the second line are both substantially parallel to the axis of the paper; and
detecting that the third point is within an area defined by a predetermined radius from the first point.

6. The electronic writing device of claim 1, wherein one or more sensors comprise one or more optical sensors.

7. The electronic writing device of claim 1, wherein the electronic writing device comprises an electronic pen.

8. The electronic writing device of claim 1, further comprising at least one of a wireless interface configured to enable wireless transfer of the writing data to a computing device, or a wired interface configured to enable wired transfer of the writing data to the computing device.

9. A method comprising:
receiving writing data via one or more sensors of an electronic writing device, the writing data comprising x-coordinates and y-coordinates corresponding to writing generated by the electronic writing device writing on a writing surface;
determining that the writing data corresponds to a calibration movement; and
determining a correction angle based on the calibration movement, the correction angle usable to adjust subsequently-received writing data by the correction angle to align the subsequently-received writing data to an orientation of the writing surface.

10. The method of claim 8, further comprising storing the correction angle in a writing buffer.

11. The method of claim 8, wherein the determining that the writing data corresponds to the calibration movement comprises detecting that the writing data corresponds to a line drawn substantially parallel to an axis of the writing surface using the electronic writing device, the axis comprising a horizontal axis of the writing surface or a vertical axis of the writing surface.

12. The method of claim 10, wherein the determining that the writing data corresponds to the calibration movement further comprises determining that the line is within one or more angle thresholds.

13. The method of claim 10, wherein the axis comprises the horizontal axis, and wherein the determining that the writing data corresponds to the calibration movement further comprises determining that a length between an x-coordinate of a first point of the line and an x-coordinate of a second point of the line is greater than a line threshold length.

14. The method of claim 10, wherein the axis comprises the vertical axis, and wherein the determining that the writing data corresponds to the calibration movement further comprises determining that a length between a y-coordinate of a first point of the line and a y-coordinate of a second point of the line is greater than a line threshold length.

15. The method of claim 10, wherein the determining the correction angle comprises:
determining a straight calibration line from a first point of the line to a second point of the line; and
determining the correction angle as an angle between the calibration line and the axis of the writing surface.

16. The method of claim 8, wherein the determining that the writing data corresponds to the calibration movement comprises:
detecting that the writing data corresponds to a first line drawn using the electronic writing device from a first point to a second point on the writing surface, and to a second line drawn using the electronic writing device from the second point to a third point on the writing surface;
detecting that the first line and the second line are both substantially parallel to the axis of the writing surface; and
detecting that the third point is within an area defined by a predetermined radius from the first point.

17. The method of claim 8, further comprising:
receiving additional writing data via the one or more sensors of the electronic writing device; and
adjusting the additional writing data by the correction angle to align the additional writing data to the orientation of the writing surface.

18. A method comprising:
receiving, via a sensor of an electronic writing device, writing data generated by the electronic writing device writing on a writing surface; and
adjusting the writing data by a correction angle to align the writing data to an orientation of the writing surface.

19. The method of claim 17, wherein the correction angle comprises one of a positive angle or a negative angle.

20. The method of claim 17, wherein the adjusting the writing data comprises adjusting x-coordinates and y-coordinates of the writing data by the correction angle.
